(19) United States
(12) Patent Application Publication
(10) Pub. No.: US 2026/0092704 A1
(43) Pub. Date: Apr. 2, 2026

(54) GAS TURBINE COMBUSTION CYLINDER, GAS TURBINE COMBUSTOR, AND GAS TURBINE

(71) Applicant: MITSUBISHI HEAVY INDUSTRIES, LTD., Tokyo (JP)

(72) Inventors: Geoffrey D. MYERS, Houston, TX (US); Kenji MIYAMOTO, Tokyo (JP); Takahiro OKANAMI, Tokyo (JP); Kenichi HASHIMOTO, Tokyo (JP); Satoshi TAKIGUCHI, Tokyo (JP)

(21) Appl. No.: 19/111,090

(22) PCT Filed: Aug. 25, 2023
(86) PCT No.: PCT/JP2023/030692

§ 371 Date: Mar. 12, 2025

Related U.S. Application Data
(60) Provisional application No. 63/418,154, filed on Oct. 21, 2022.

(51) Int. Cl. F23R 3/10; F23R 3/46

(52) U.S. Cl. CPC F23R 3/10; F23R 3/46

(57) ABSTRACT

A gas turbine combustion cylinder includes: a combustion cylinder; fuel nozzles arranged, on a lateral side of the combustion cylinder, apart from each other in a circumferential direction; and a wind shield cover enclosing at least one of the fuel nozzles. The wind shield cover includes a top plate extending in the circumferential direction, and a circumferential-direction lateral wall that connects the combustion cylinder and a circumferential end of the top plate. The wind shield cover is defined by the top plate and the circumferential-direction lateral wall, and has a suction opening for taking in combustion air. A radial size of the combustion cylinder at the suction opening is smaller than a circumferential size of the combustion cylinder at the suction opening at least in a partial region in the circumferential direction.

The present disclosure claims priority based on U.S. Application No. 63/418,154 filed with the United States Patent and Trademark Office on Oct. 21, 2022, the content of which is incorporated herein by reference.

### TECHNICAL FIELD

The present disclosure relates to a gas turbine combustion cylinder, a gas turbine combustor, and a gas turbine.

### BACKGROUND ART

A gas turbine combustor that can supply a fuel into a combustion cylinder from a fuel nozzle provided in a side portion of a combustion cylinder of the gas turbine combustor is known. This gas turbine combustor is configured so that compressed air compressed by a compressor is taken into the combustion cylinder from a periphery of the gas turbine combustor, as combustion air (for example, refer to PTL 1).

### CITATION LIST

### Patent Literature

[PTL 1] Japanese Unexamined Patent Application Publication No. 2017-166808

### SUMMARY OF INVENTION

### Technical Problem

In general, in an industrial gas turbine, since a plurality of combustors are annularly disposed around a rotor, an interval between the combustors adjacent to each other is relatively narrow. Therefore, a flow velocity of combustion air flowing between combustion cylinders of the adjacent combustors is relatively high. As a result, a flow rate of the combustion air flowing into a fuel nozzle provided in a side portion of the combustion cylinder is greatly affected by a position in a circumferential direction of the combustion cylinder provided with the fuel nozzle. However, PTL 1 described above does not particularly disclose suppressing influence received by the position in the circumferential direction of the combustion cylinder provided with the fuel nozzle.

In view of the above-described circumstances, at least one embodiment of the present disclosure aims to provide a gas turbine combustion cylinder which can suppress a pressure loss of combustion air flowing into a plurality of fuel nozzles while suppressing a flow rate deviation of the combustion air between the plurality of fuel nozzles disposed at an interval in a circumferential direction of the combustion cylinder.

### Solution to Problem

(1) According to at least one embodiment of the present disclosure, there is provided a gas turbine combustion cylinder including a combustion cylinder, a plurality of fuel nozzles disposed at an interval in a circumferential direction of the combustion cylinder on a side portion of the combustion cylinder, and a windbreak cover disposed to enclose at least one of the plurality of fuel nozzles. The windbreak cover includes a top plate extending in the circumferential direction and a circumferential side wall that connects an end portion of the top plate in the circumferential direction and the combustion cylinder. The windbreak cover is formed by the top plate and the circumferential side wall, and has a suction opening portion for taking in combustion air. A dimension in a radial direction of the combustion cylinder in the suction opening portion is smaller than a dimension in the circumferential direction in the suction opening portion in at least a partial region in the circumferential direction.
(2) According to at least one embodiment of the present disclosure, there is provided a gas turbine combustor including the combustion cylinder having a configuration of (1), and a burner provided on an upstream side of the combustion cylinder and used for combusting a fuel.
(3) According to at least one embodiment of the present disclosure, there is provided a gas turbine including a rotor, and a plurality of the combustors having a configuration of (2), which are annularly disposed around the rotor.

### Advantageous Effects of Invention

According to at least one embodiment of the present disclosure, it is possible to suppress a pressure loss of combustion air flowing into a plurality of fuel nozzles while suppressing a flow rate deviation of the combustion air between the plurality of fuel nozzles disposed at an interval in a circumferential direction of the combustion cylinder.

### BRIEF DESCRIPTION OF DRAWINGS

FIG. 1 is a schematic configuration diagram of a gas turbine according to an embodiment.

FIG. 2 is a schematic view illustrating an inlet portion of a combustor and a turbine of a gas turbine according to the embodiment.

FIG. 3A is a schematic cross-sectional view of a combustion cylinder according to the embodiment, and schematically illustrates a cross section taken along line III-III in FIG. 2.

FIG. 3B is a schematic cross-sectional view of a combustion cylinder according to another embodiment, and schematically illustrates a cross section taken along line III-III in FIG. 2.

FIG. 3C is a schematic cross-sectional view of a combustion cylinder according to still another embodiment, and schematically illustrates a cross section taken along line III-III in FIG. 2.

FIG. 3D is a schematic cross-sectional view of a combustion cylinder according to still another embodiment, and schematically illustrates a cross section taken along line III-III in FIG. 2.

FIG. 3E is a schematic cross-sectional view of a combustion cylinder according to still another embodiment, and schematically illustrates a cross section taken along line III-III in FIG. 2.

FIG. 4 is a cross-sectional view for describing a structure of a windbreak cover, and illustrates a cross section taken along line IV-IV in FIG. 3A as an example.

FIG. 5 is a diagram schematically illustrating a cross section in a radial direction with regard to the windbreak cover and a third fuel nozzle to describe a flow of combustion air flowing into the third fuel nozzle.

FIG. 6 is a schematic cross-sectional view when two adjacent combustors in a plurality of combustors disposed in a circumferential direction of a rotor are viewed from a downstream side in an axial direction of the combustion cylinder, and schematically illustrates a cross section at an axial position corresponding to the cross section taken along line III-III in FIG. 2.

### DESCRIPTION OF EMBODIMENTS

Hereinafter, some embodiments of the present disclosure will be described with reference to the accompanying drawings. However, dimensions, materials, shapes, and relative dispositions of components described as the embodiments or illustrated in the drawings are not intended to limit the scope of the present disclosure, and are merely examples for describing the present disclosure.

For example, expressions representing relative or absolute dispositions such as “in a certain direction”, “along a certain direction”, “parallel”, “orthogonal”, “center”, “concentric”, or “coaxial” not only strictly represent the dispositions, but also represent a state where the dispositions are relatively displaced with a tolerance or at an angle or a distance to such an extent that the same function can be obtained.

For example, expressions representing that things are in an equal state such as “same”, “equal”, and “homogeneous” not only strictly represent an equal state, but also represent a state where a difference exists with a tolerance or to such an extent that the same function can be obtained.

For example, expressions representing shapes such as a quadrangular shape and a cylindrical shape not only represent shapes such as a quadrangular shape and a cylindrical shape in a geometrically strict sense, but also represent shapes including an uneven portion or a chamfered portion within a range where the same effect can be obtained.

In addition, expressions of “being provided with”, “being equipped with”, “including”, or “having” one component are not exclusive expressions excluding the presence of other components.

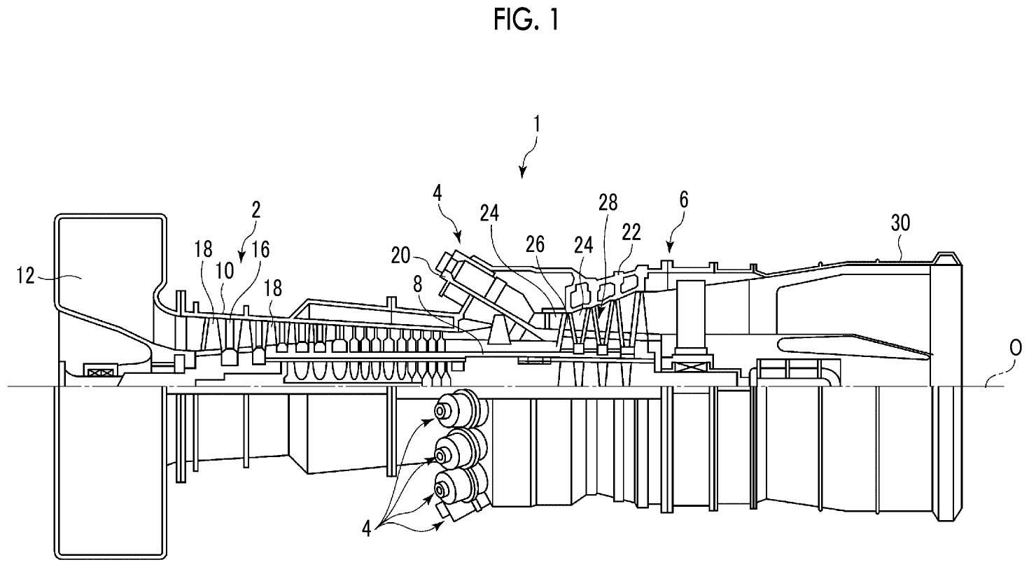

First, a gas turbine as an example of an application target of a fuel supply pipe assembly according to an embodiment will be described with reference to FIG. 1. FIG. 1 is a schematic configuration diagram of a gas turbine according to the embodiment.

As illustrated in FIG. 1, a gas turbine 1 includes a compressor 2 for generating compressed air, a gas turbine combustor (combustor) 4 for generating combustion gas by using the compressed air and a fuel, and a turbine 6 configured to be rotationally driven by the combustion gas. In a case of the gas turbine 1 for power generation, a generator (not illustrated) is connected to the turbine 6.

The compressor 2 includes a plurality of stator vanes 16 fixed to a side of a compressor casing 10, and a plurality of rotor blades 18 embedded in a rotor 8 to be alternately arranged with respect to the stator vanes 16.

Air taken in from an air intake port 12 is fed to the compressor 2. The air passes through the plurality of stator vanes 16 and the plurality of rotor blades 18, and is compressed to be high-temperature and high-pressure compressed air.

The fuel and the compressed air generated by the compressor 2 are supplied to the combustor 4, and the fuel is combusted in the combustor 4. In this manner, combustion gas serving as a working fluid of the turbine 6 is generated. As illustrated in FIG. 1, the gas turbine 1 includes a plurality of combustors 4 disposed along a circumferential direction around the rotor 8 inside a casing 20.

The turbine 6 includes a combustion gas passage 28 formed by a turbine casing 22, and includes a plurality of stator vanes 24 and a plurality of rotor blades 26 which are provided in the combustion gas passage 28. The stator vanes 24 and the rotor blades 26 of the turbine 6 are provided on a downstream side of the combustor 4 with respect to a flow of the combustion gas.

The stator vane 24 is fixed to a side of the turbine casing 22, and a stator vane row is formed by the plurality of stator vanes 24 arranged along the circumferential direction of the rotor 8. In addition, the rotor blade 26 is embedded in the rotor 8, and a rotor blade row is formed by the plurality of rotor blades 26 arranged along the circumferential direction of the rotor 8. The stator vane row and the rotor blade row are alternately arranged in an axial direction of the rotor 8.

In the turbine 6, the combustion gas flowing into the combustion gas passage 28 from the combustor 4 passes through the plurality of stator vanes 24 and the plurality of rotor blades 26 so that the rotor 8 is rotationally driven around an axis O. In this manner, a generator connected to the rotor 8 is driven to generate power. After the turbine 6 is driven, the combustion gas is discharged to an outside via an exhaust chamber 30.

Next, the combustor 4 according to the embodiment will be described.

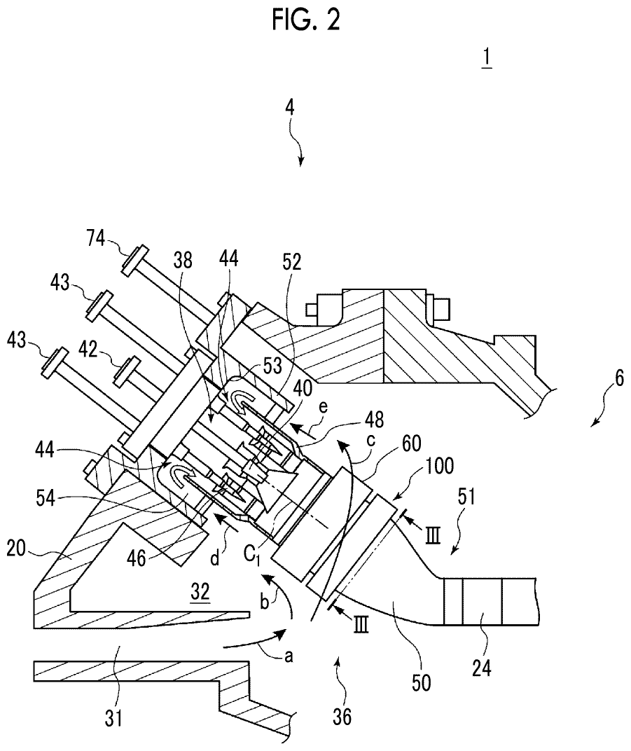

FIG. 2 is a schematic view illustrating an inlet portion of the combustor 4 and the turbine 6 of the gas turbine 1 according to the embodiment.

In the gas turbine 1 according to some embodiments, each of the plurality of combustors 4 (refer to FIG. 1) disposed in the circumferential direction around the rotor 8 includes a combustion cylinder (combustor liner) 36 provided in a combustor casing 32 defined by the casing 20, first combustion burners 38 respectively disposed in the combustion cylinder 36, and a plurality of second combustion burners 44 disposed to enclose the first combustion burner 38. That is, the combustion cylinder 36, the first combustion burner 38, and the second combustion burner 44 are accommodated in the casing 20.

The combustion cylinder (combustor liner) 36 includes an inner cylinder 48 disposed around the first combustion burner 38 and the plurality of second combustion burners 44, and a transition piece 50 connected to a tip portion of the inner cylinder 48. The inner cylinder 48 and the transition piece 50 may be integrally formed.

An acoustic device 60 for attenuating combustion vibration is provided on an outer periphery of the combustion cylinder 36.

The first combustion burner 38 is disposed along a direction of a central axis C₁ of the combustion cylinder 36 (that is, the axial direction of the combustor 4 and the combustion cylinder 36), and includes a first fuel nozzle 40 for injecting a fuel. The fuel is supplied to the first fuel nozzle 40 via a first fuel port 42.

The second combustion burner 44 includes a second fuel nozzle 46 for injecting the fuel. The fuel is supplied to the second fuel nozzle 46 via a second fuel port 43.

The combustor 4 further includes an outer cylinder 52 provided on an outer peripheral side of the inner cylinder 48 inside the casing 20. An air passage 54 through which the compressed air flows is formed on an outer peripheral side of the inner cylinder 48 and an inner peripheral side of the outer cylinder 52.

The compressed air generated by the compressor 2 (refer to FIG. 1) is supplied into the combustor casing 32 via a casing inlet 31, and the compressed air flows into the air passage 54 from the combustor casing 32 as combustion air, a flowing direction thereof is changed by a wall surface portion 53 provided along a surface orthogonal to the axial direction of the combustor 4, and the compressed air flows into a first burner cylinder 41 and a second burner cylinder 47. In each burner cylinder, the fuel injected from the fuel nozzle and the compressed air (combustion air) are mixed. The mixed gas flows into the combustion cylinder 36, and is ignited and combusted. In this manner, the combustion gas is generated.

The combustion gas generated by combusting the fuel in the combustor 4 flows into the turbine 6 via an outlet portion 51 of the combustor 4 located in a downstream end portion of the transition piece 50.

### Third Fuel Nozzle 70

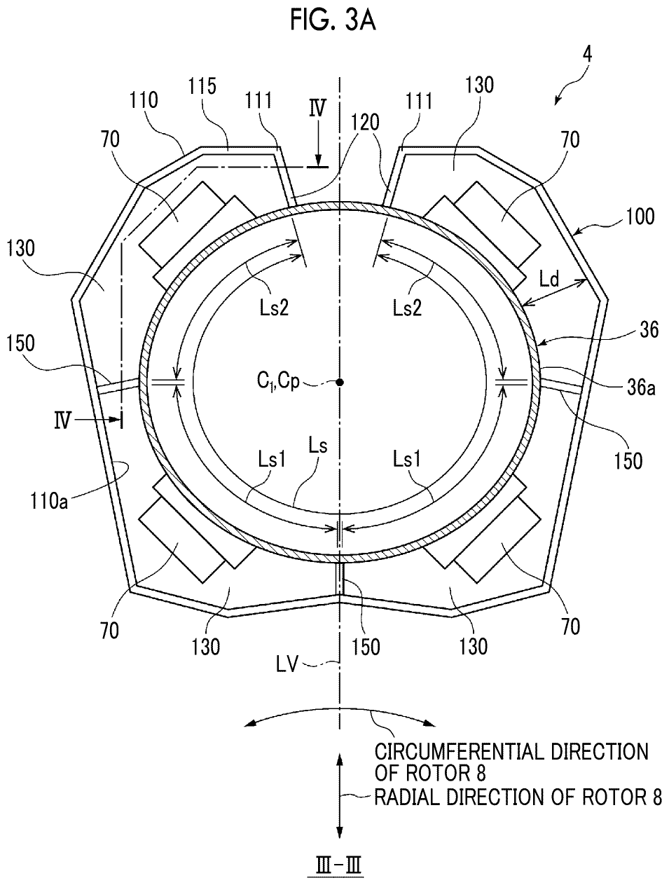

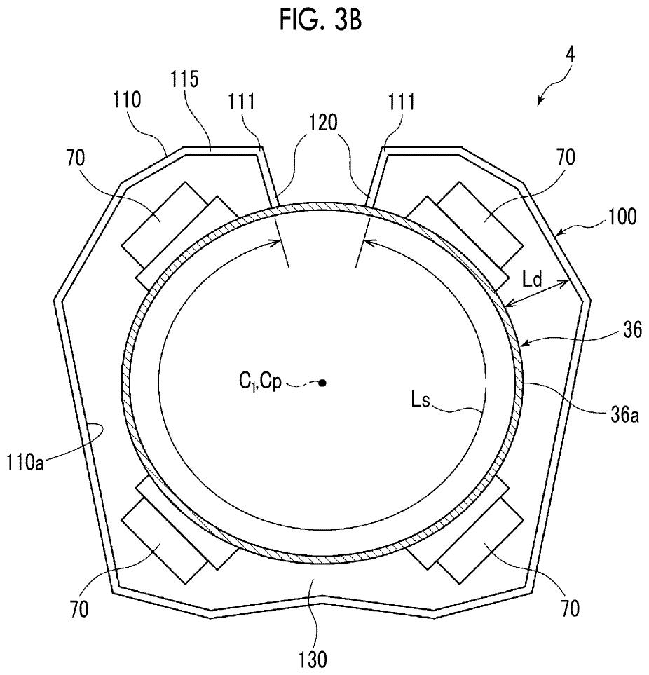

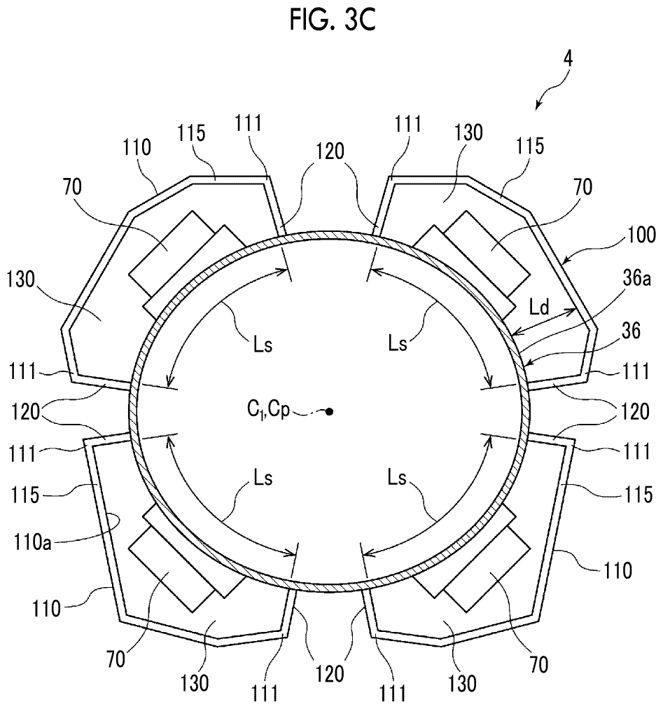

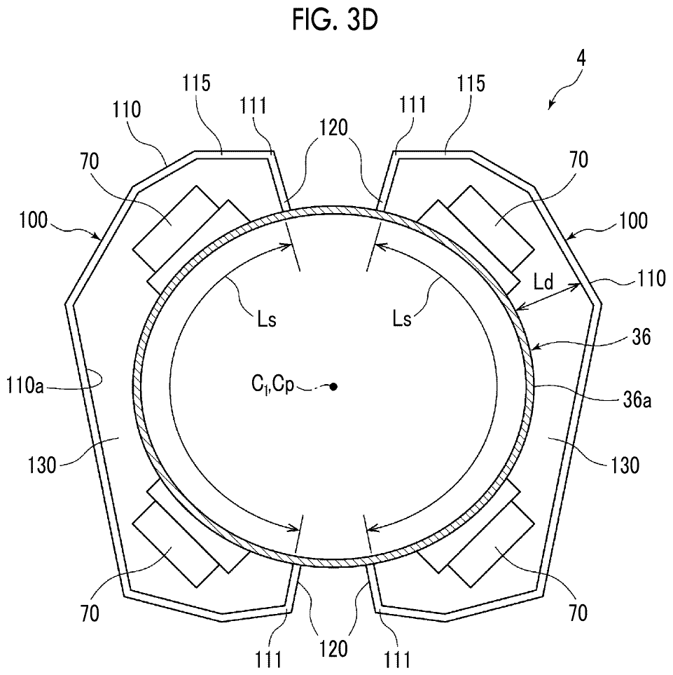

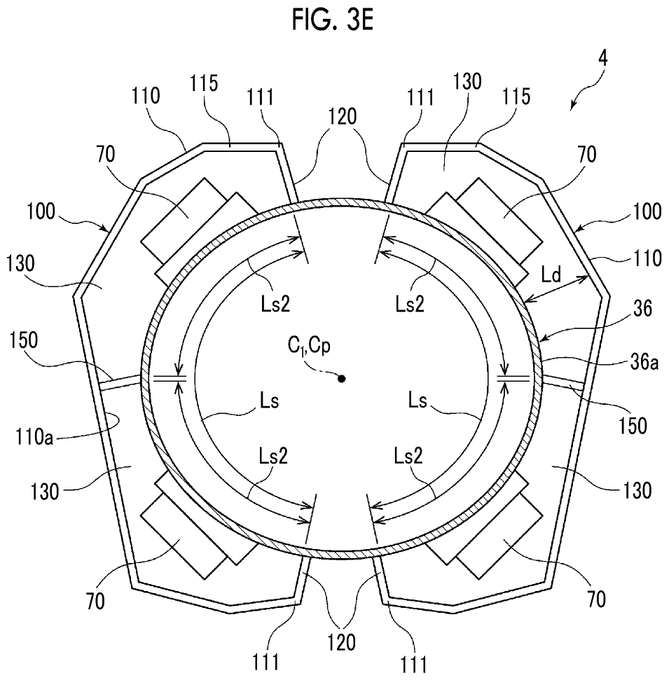

FIG. 3A is a schematic cross-sectional view of the combustion cylinder 36 according to the embodiment, and schematically illustrates a cross section taken along line III-III in FIG. 2.

FIG. 3B is a schematic cross-sectional view of the combustion cylinder 36 according to another embodiment, and schematically illustrates a cross section taken along line III-III in FIG. 2.

FIG. 3C is a schematic cross-sectional view of the combustion cylinder 36 according to still another embodiment, and schematically illustrates a cross section taken along line III-III in FIG. 2.

FIG. 3D is a schematic cross-sectional view of the combustion cylinder 36 according to still another embodiment, and schematically illustrates a cross section taken along line III-III in FIG. 2.

FIG. 3E is a schematic cross-sectional view of the combustion cylinder 36 according to still another embodiment, and schematically illustrates a cross section taken along line III-III in FIG. 2.

The combustor 4 according to some embodiments is provided in a side portion of the combustion cylinder 36, and includes a plurality of third fuel nozzles 70 disposed at an interval along the circumferential direction (that is, the circumferential direction of the combustor 4 and the combustion cylinder 36) around the central axis C₁. That is, the third fuel nozzle 70 is a fuel nozzle for supplying the fuel into the combustion cylinder 36 from a side portion of the combustion cylinder 36.

For example, the third fuel nozzle 70 is fixed to the transition piece 50.

In the combustor 4 according to some embodiments, each of the third fuel nozzles 70 is disposed inside a region defined by a windbreak cover 100 (to be described later) that covers the combustion cylinder 36 from an outer side in the radial direction of the combustion cylinder 36 around the central axis C₁, and the combustion cylinder 36.

The fuel is supplied to the third fuel nozzle 70 via a third fuel port 74 (refer to FIG. 2). In FIG. 2, description of a fuel supply pipe from the third fuel port 74 to each of the third fuel nozzles 70 is omitted.

In the combustor 4 according to some embodiments, four third fuel nozzles 70 are provided at an interval in the circumferential direction of the combustion cylinder 36. In addition, in the combustor 4 according to some embodiments, the third fuel nozzle 70 may be disposed to pass through a center Cp (that is, the central axis C₁) of the combustion cylinder 36 when viewed along the central axis C₁ and to be symmetrical on one side and the other side in the circumferential direction of the rotor 8 across a virtual straight line LV (refer to FIG. 3A) extending in the radial direction of the rotor 8.

The number of the third fuel nozzles 70 provided in one combustor 4 according to some embodiments is not limited to four, and may be one or more, two or three, or five or more.

When the fuel is injected into the combustion cylinder 36 from the third fuel nozzle 70, the combustion air inside the combustion cylinder 36 is mixed with the injected fuel, and the mixed fuel is combusted. Since the fuel is injected into the combustion cylinder 36 from the third fuel nozzle 70, the fuel can be supplied to a secondary combustion zone inside a transition portion downstream of a primary combustion region where the fuel supplied from the first fuel nozzle 40 and the second fuel nozzle 46 is combusted. In this manner, combustion efficiency can be improved while generation of nitrogen oxides (NOₓ) is suppressed.

The combustor 4 may include other components such as a bypass pipe (not illustrated) for bypassing the combustion gas.

### Regarding Necessity of Windbreak Cover 100

In the gas turbine 1 according to some embodiments, as described above, the plurality of combustors 4 are disposed in the circumferential direction around the rotor 8. Therefore, an interval between the combustors 4 adjacent to each other is relatively narrow.

The compressed air generated by the compressor 2 (refer to FIG. 1) is supplied into the combustor casing 32 via a casing inlet 31 as indicated by an arrow a, at an inner position in the radial direction around the rotor 8 with respect to the plurality of combustors 4 adjacent to each other in the circumferential direction around the rotor 8. The compressed combustion air introduced into the combustor casing 32 flows as indicated by arrows b and c. Thereafter, while being directed outward in the radial direction of the gas turbine, the flow is changed to be directed toward an upstream side in the axial direction of the gas turbine 1 as indicated by arrows d and e, and the compressed air flows into the combustion cylinder 36 from the upstream side in the axial direction of the combustion cylinder 36.

After the compressed air flows into the combustor casing 32 in this way, in a process of flowing into the combustion cylinder 36, as indicated by an arrow c, a portion of the compressed air passes through a space (gap) in which a relative interval between the combustion cylinders 36 of the combustors 4 adjacent to each other in the circumferential direction around the rotor 8 is narrow.

Therefore, a deviation occurs in a flow rate of the combustion air flowing into the third fuel nozzle 70 between the plurality of third fuel nozzles 70 disposed at an interval in the circumferential direction of the combustion cylinder 36. That is, in the plurality of third fuel nozzles 70, for example, two third fuel nozzles 70 illustrated on a lower side in FIG. 3A are located inward in the radial direction around the rotor 8 with respect to two third fuel nozzles 70 illustrated on an upper side in FIG. 3A. Therefore, the flow rate of the flowing combustion air tends to be higher than the flow rate of the flowing combustion air of the two third fuel nozzles 70 illustrated on the upper side in FIG. 3A.

When concentration of the mixed gas injected from the third fuel nozzle 70 is varied by the third fuel nozzle 70 due to a flow rate deviation of the combustion air between the plurality of third fuel nozzles 70, the concentration of the mixed gas injected into the combustion cylinder 36 from a plurality of locations in the circumferential direction of the combustion cylinder 36 is not uniform. Consequently, there is a possibility of abnormal combustion.

Therefore, in the combustor 4 according to some embodiments, the windbreak cover 100 is provided to suppress the flow rate deviation of the combustion air between the plurality of third fuel nozzles 70 as described above.

### Regarding Structure of Windbreak Cover 100

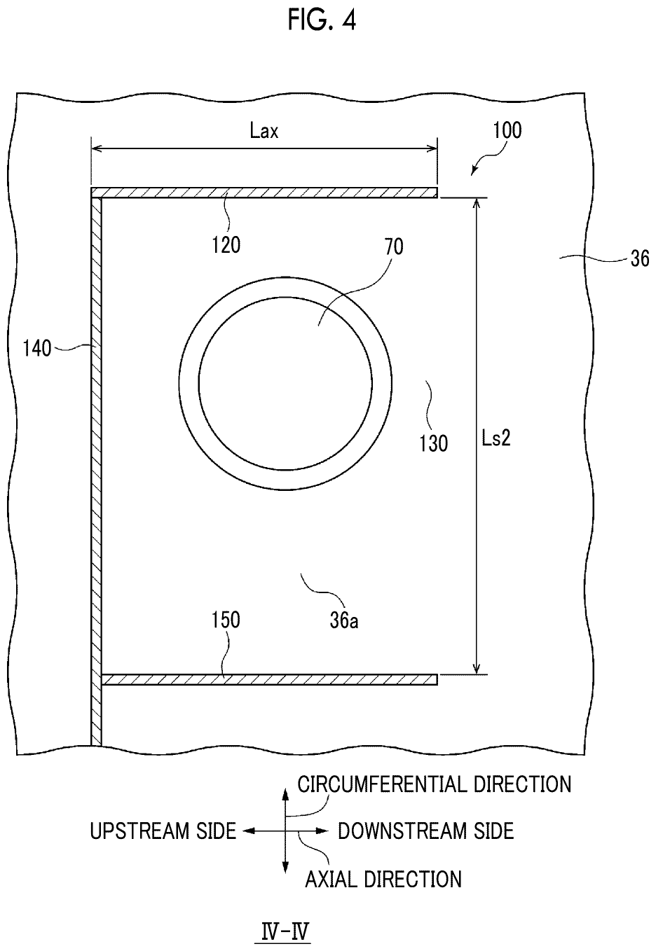

FIG. 4 is a cross-sectional view for describing a structure of the windbreak cover 100, and illustrates a cross section taken along line IV-IV in FIG. 3A as an example.

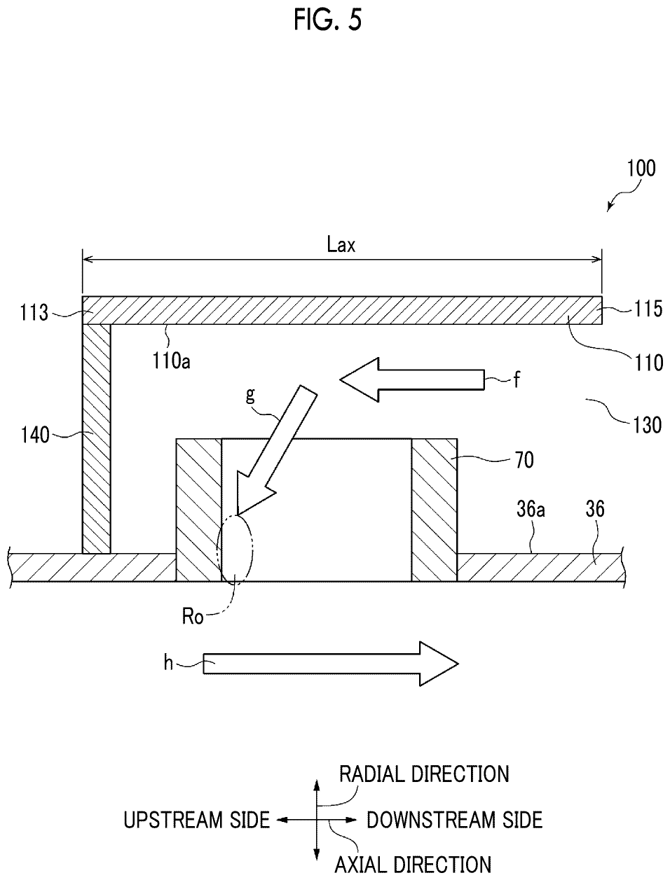

FIG. 5 is a diagram schematically illustrating a cross section in the radial direction of the windbreak cover 100 and the third fuel nozzle 70 for describing the flow of the combustion air flowing into the third fuel nozzle 70.

In the following description, the circumferential direction of the combustion cylinder 36, the radial direction of the combustion cylinder 36, and the axial direction of the combustion cylinder 36 will be simply referred to as the circumferential direction, the radial direction, and the axial direction, respectively.

In addition, in the following description, the upstream side of the flow of the combustion gas in the combustion cylinder 36 will be referred to as the upstream side of the combustion cylinder 36 or the upstream side in the axial direction, and the downstream side of the flow of the combustion gas in the combustion cylinder 36 will be referred to as the downstream side of the combustion cylinder 36 or the downstream side in the axial direction.

As illustrated in FIGS. 3A to 3E, in the combustion cylinder 36 according to some embodiments, the windbreak cover 100 includes a top plate 110 that extends in the circumferential direction, and a circumferential side wall 120 that connects an end portion 111 in the circumferential direction in the top plate 110 and the combustion cylinder 36.

As illustrated in FIGS. 3A to 3E, in the combustion cylinder 36 according to some embodiments, the windbreak cover 100 is formed by the top plate 110 and the circumferential side wall 120, and includes a suction opening portion 130 for taking in the combustion air.

The windbreak cover 100 illustrated in FIGS. 3A to 3E may include an upstream side wall 140 that connects an end portion 113 (refer to FIG. 5) of the top plate 110 on the upstream side of the combustion cylinder 36 and the combustion cylinder 36.

In the windbreak cover 100 illustrated in FIGS. 3A to 3E, the top plate 110 is a plate-shaped member disposed at an interval from an outer peripheral surface 36a of the combustion cylinder 36 to cover the third fuel nozzle 70 from the outside in the radial direction, and extends in the circumferential direction and the axial direction.

In the windbreak cover 100 illustrated in FIGS. 3A to 3E, the circumferential side wall 120 is a plate-shaped member that connects an end portion 111 on one side and an end portion 111 on the other side in the circumferential direction in the top plate 110 and the combustion cylinder 36. In the windbreak cover 100 illustrated in FIGS. 3A to 3E, the circumferential side wall 120 closes a gap between the top plate 110 and the combustion cylinder 36 in the end portion 111 on one side and the end portion 111 on the other side in the circumferential direction.

In the windbreak cover 100 illustrated in FIGS. 3A to 3E, the upstream side wall 140 is a plate-shaped member that connects an end portion 113 of the top plate 110 on the upstream side of the combustion cylinder 36 and the combustion cylinder 36. In the windbreak cover 100 illustrated in FIGS. 3A to 3E, the upstream side wall 140 closes a gap between the top plate 110 and the combustion cylinder 36 in the end portion 113 of the top plate 110 on the upstream side of the combustion cylinder 36.

In the windbreak cover 100 illustrated in FIGS. 3A to 3E, the suction opening portion 130 is an opening portion of the windbreak cover 100 defined by the top plate 110 and the circumferential side wall 120 provided in the end portion 111 on one side and the end portion 111 on the other side in the circumferential direction of the top plate 110, in the end portion 115 on the downstream side of the combustion cylinder 36 in the top plate 110.

Although not illustrated, when the upstream side wall 140 is not provided, the suction opening portion 130 is also formed in the end portion 113 of the top plate 110 on the upstream side of the combustion cylinder 36.

The windbreak cover 100 illustrated in FIGS. 3A and 3B is configured so that all of the third fuel nozzles 70 are accommodated inside a space defined by one windbreak cover 100.

The windbreak cover 100 illustrated in FIG. 3C is configured so that one third fuel nozzle 70 is accommodated inside a space defined by one windbreak cover 100.

The windbreak cover 100 illustrated in FIGS. 3D and 3E is configured so that two third fuel nozzles 70 are accommodated inside the space defined by one windbreak cover 100. In an example illustrated in FIGS. 3D and 3E, the windbreak cover 100 is provided on each of one side and the other side in the circumferential direction of the rotor 8 across the virtual straight line LV (refer to FIG. 3A).

The windbreak cover 100 illustrated in FIGS. 3A and 3E is provided with a bulkhead 150 that connects the top plate 110 and the combustion cylinder 36 and that divides a space enclosed by the top plate 110, the circumferential side wall 120, and the combustion cylinder 36 in the circumferential direction.

In the windbreak cover 100 illustrated in FIGS. 3A and 3E, the bulkhead 150 is disposed between two third fuel nozzles 70 adjacent to each other in the circumferential direction inside the windbreak cover 100.

In the combustion cylinder 36 illustrated in FIG. 3A, the two third fuel nozzles 70 provided outward in the radial direction are each disposed between the circumferential side wall 120 provided on one side in the circumferential direction and the bulkhead 150 provided on the other side in the circumferential direction.

In the combustion cylinder 36 illustrated in FIG. 3A, the two third fuel nozzles 70 provided inward in the radial direction are each disposed between the bulkheads 150 provided on one side and the other side in the circumferential direction.

In the combustion cylinder 36 illustrated in FIG. 3E, the four third fuel nozzles 70 are each disposed between the circumferential side wall 120 provided on one side in the circumferential direction and the bulkhead 150 provided on the other side in the circumferential direction.

Although not illustrated in the drawing, the combustion cylinder 36 may include one windbreak cover 100 configured to accommodate the two third fuel nozzles 70 provided outward in the radial direction and one windbreak cover 100 configured to accommodate the two third fuel nozzles 70 provided inward in the radial direction.

In this case, the bulkhead 150 may or may not be provided between the third fuel nozzle 70 on one side in the circumferential direction of the rotor 8 and the third fuel nozzle 70 on the other side across the virtual straight line LV (refer to FIG. 3A).

In the combustion cylinder 36 illustrated in FIGS. 3A to 3E, since the windbreak cover 100 configured as described above is provided, the flow rate deviation of the combustion air as described above can be suppressed between the plurality of third fuel nozzles 70 disposed at an interval in the circumferential direction on the side portion of the combustion cylinder 36.

In the windbreak cover 100 illustrated in FIGS. 3A to 3E configured as described above, a dimension Ld in the radial direction in the suction opening portion 130 is smaller than a dimension Ls in the circumferential direction in the suction opening portion 130, in at least a partial region in the circumferential direction.

As in the examples illustrated in FIGS. 3A to 3E, the dimension Ld in the radial direction in the suction opening portion 130 may be smaller than the dimension Ls in the circumferential direction in the suction opening portion 130 in all of the regions in the circumferential direction.

The dimension Ls in the circumferential direction in the suction opening portion 130 may be a dimension obtained by tracing the outer peripheral surface 36a of the combustion cylinder 36 in the circumferential direction, or may be a dimension obtained by tracing an inner peripheral surface 110a of the top plate 110 in the circumferential direction. In addition, the dimension Ls in the circumferential direction in the suction opening portion 130 may be a dimension obtained by dividing a sum of the dimension obtained by tracing the outer peripheral surface 36a of the combustion cylinder 36 in the circumferential direction and the dimension obtained by tracing the inner peripheral surface 110a of the top plate 110 in the circumferential direction by 2. The dimension Ls in the circumferential direction in the suction opening portion 130 may be a dimension obtained by tracing an intermediate position between the outer peripheral surface 36a of the combustion cylinder 36 and the inner peripheral surface 110a of the top plate 110 in the circumferential direction.

According to the combustion cylinder 36 illustrated in FIGS. 3A to 3E configured as described above, even when a plurality of combustion cylinders 36 are annularly disposed around the rotor 8 of the gas turbine 1, a pressure loss of the combustion air flowing into the third fuel nozzle 70 can be suppressed by securing a size of the suction opening portion 130 while preventing interference with the windbreak cover 100 provided in the adjacent combustion cylinders 36.

The combustor 4 according to some embodiments includes the combustion cylinder 36 having any of the configurations illustrated in FIGS. 3A to 3E, and the first combustion burner 38 and the second combustion burner 44 which are provided on the upstream side in the axial direction of the combustion cylinder 36 as the burner for combusting the fuel.

In this manner, it is possible to realize the combustor 4 which can suppress the pressure loss of the combustion air flowing into the third fuel nozzle 70 while suppressing the flow rate deviation of the combustion air between the plurality of third fuel nozzles 70 disposed at an interval in the circumferential direction of the combustion cylinder 36 in the side portion of the combustion cylinder 36.

The gas turbine 1 according to some embodiments includes the rotor 8 and the plurality of combustors 4 annularly disposed around the rotor 8 and configured as described above.

In this manner, efficiency of the gas turbine 1 is improved.

In the windbreak cover 100 illustrated in FIGS. 3A to 3E, the side portion in the circumferential direction is closed by the circumferential side wall 120 as described above, and the end portion on the upstream side in the axial direction is closed by the upstream side wall 140. Therefore, the combustion air flows into the windbreak cover 100 from the suction opening portion 130 provided on the downstream side in the axial direction as indicated by an arrow f in FIG. 5.

Therefore, in the windbreak cover 100 illustrated in FIGS. 3A to 3E, the combustion air flows into the third fuel nozzle 70 from the downstream side in the axial direction. As indicated by the arrow f in FIG. 5, the combustion air flowing into the third fuel nozzle 70 from the downstream side in the axial direction flows into the combustion cylinder 36 by changing the direction of the flow in the third fuel nozzle 70 as indicated by an arrow g in FIG. 5. In this manner, a region where the flow velocity of the combustion air is lowered in a region Ro on the upstream side in the axial direction in the vicinity of an outlet of the third fuel nozzle 70 is unlikely to form. In this manner, occurrence of abnormal combustion in the vicinity of the outlet of the third fuel nozzle 70 can be suppressed.

In FIG. 5, an arrow h indicates a flow of the combustion gas inside the combustion cylinder 36.

In the windbreak cover 100 illustrated in FIGS. 3A to 3E, a dimension Lax (refer to FIG. 5) in the axial direction in the top plate 110 may be smaller than the dimension in the circumferential direction in the top plate 110, that is, the dimension Ls in the circumferential direction in the suction opening portion 130.

In this manner, it is possible to suppress interference between the acoustic device 60 provided in the combustion cylinder 36 on the upstream side of the windbreak cover 100 in the axial direction and the windbreak cover 100.

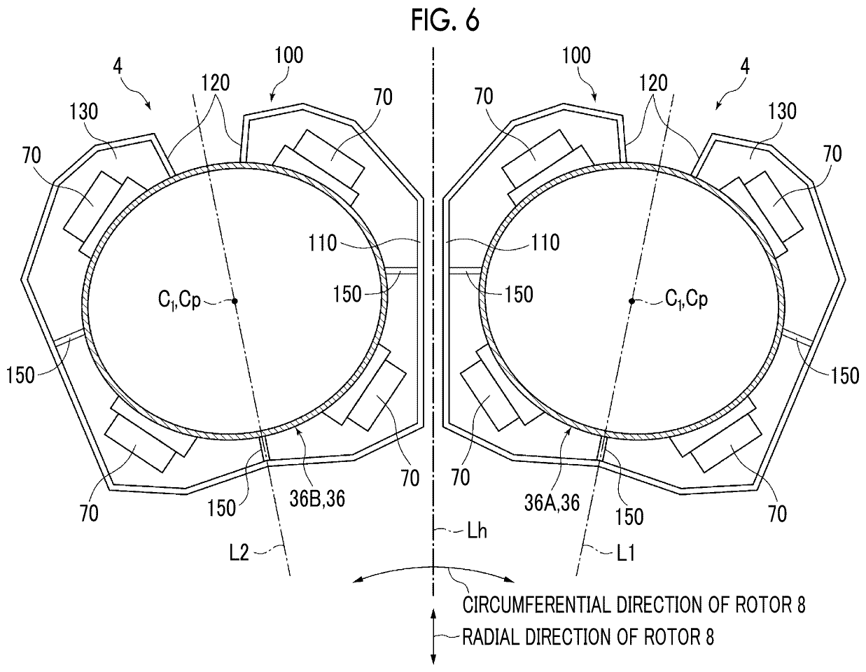

FIG. 6 is a schematic cross-sectional view when two adjacent combustors 4 in the plurality of combustors 4 disposed in the circumferential direction of the rotor 8 are viewed from the downstream side of the combustion cylinder 36 in the axial direction, and schematically illustrates a cross section at an axial position corresponding to the cross section taken along line III-III in FIG. 2.

For example, as illustrated in FIG. 6, the combustion cylinders 36 illustrated in FIGS. 3A to 3E include at least a first combustion cylinder 36A and a second combustion cylinder 36B disposed adjacent to the first combustion cylinder 36A, which are annularly disposed at a plurality of locations around the rotor 8 of the gas turbine 1. When viewed in a direction of the axis O of the rotor 8 (from the downstream side in the axial direction of the combustion cylinder 36), and when a straight line passing through the axis O of the rotor 8 and the center Cp of the first combustion cylinder 36A is defined as a first straight line L1 and a straight line passing through the axis O and the center Cp of the second combustion cylinder 36B is defined as a second straight line L2, a portion of the top plate 110 located in a region interposed between the first straight line L1 and the second straight line L2 may extend parallel to a bisector Lh of an angle formed by the first straight line L1 and the second straight line L2.

In general, in the industrial gas turbine 1, the interval between the plurality of two adjacent combustion cylinders 36 annularly disposed around the rotor 8 of the gas turbine 1 is relatively narrow.

According to the combustion cylinder 36 illustrated in FIGS. 3A to 3E, even when the interval between the first combustion cylinder 36A and the second combustion cylinder 36B is relatively narrow, it is easy to secure a size of the suction opening portion 130, and it is easy to suppress the pressure loss of the combustion air flowing into the third fuel nozzle 70.

In the combustion cylinder 36 illustrated in FIGS. 3A and 3B, the windbreak cover 100 is configured so that all of the plurality of third fuel nozzles 70 are located between the circumferential side wall 120 on one side in the circumferential direction and the circumferential side wall 120 on the other side.

In this manner, all of the plurality of third fuel nozzles 70 disposed at an interval in the circumferential direction of the combustion cylinder 36 can be covered with one windbreak cover 100. Therefore, a configuration of the windbreak cover 100 can be relatively simplified.

In the combustion cylinder 36 illustrated in FIGS. 3A and 3E, the bulkhead 150 is provided in the windbreak cover 100. Therefore, an opening area of the suction opening portion 130 can be appropriately set depending on a position in the circumferential direction of the bulkhead 150. In this manner, it is easy to suppress the flow rate deviation of the combustion air between the plurality of third fuel nozzles 70. In addition, according to the combustion cylinder 36 illustrated in FIGS. 3A and 3E, the top plate 110 can be reinforced by the bulkhead 150.

In the combustion cylinder 36 illustrated in FIGS. 3A to 3E, the dimension Ld in the radial direction in the suction opening portion 130 may be smaller than a distance Ls1 in the circumferential direction between two bulkheads 150 adjacent to each other in the circumferential direction across at least one third fuel nozzle 70, or a distance Ls2 in the circumferential direction between the circumferential side wall 120 and the bulkhead 150 which are adjacent to each other in the circumferential direction across the third fuel nozzle 70, in at least a partial region in the circumferential direction.

In this manner, even when the plurality of combustion cylinders 36 are annularly disposed around the rotor 8 of the gas turbine 1, it is possible to suppress the pressure loss of the combustion air flowing into the third fuel nozzle 70 by securing the size of the suction opening portion 130 while preventing the interference with the windbreak cover 100 provided in the adjacent combustion cylinders 36.

The distance Ls1 and the distance Ls2 may be a dimension obtained by tracing the outer peripheral surface 36a of the combustion cylinder 36 in the circumferential direction, or may be a dimension obtained by tracing the inner peripheral surface 110a of the top plate 110 in the circumferential direction. In addition, the distance Ls1 and the distance Ls2 may be a dimension obtained by dividing a sum of the dimension obtained by tracing the outer peripheral surface 36a of the combustion cylinder 36 in the circumferential direction and the dimension obtained by tracing the inner peripheral surface 110a of the top plate 110 in the circumferential direction by 2. The distance Ls1 and the distance Ls2 may be a dimension obtained by tracing an intermediate position between the outer peripheral surface 36a of the combustion cylinder 36 and the inner peripheral surface 110a of the top plate 110 in the circumferential direction.

The present disclosure is not limited to the above-described embodiments, and also includes a form in which modifications are added to the above-described embodiments or a form in which the embodiments are combined with each other as appropriate.

For example, contents described in each of the above-described embodiments are understood as follows.

(1) In the combustion cylinder 36 of the gas turbine 1 according to at least one embodiment of the present disclosure, the combustion cylinder 36 of the gas turbine 1 includes the combustion cylinder 36, the plurality of fuel nozzles (third fuel nozzles 70) disposed at an interval in the circumferential direction of the combustion cylinder 36 on the side portion of the combustion cylinder 36, and the windbreak cover 100 disposed to enclose at least one of the plurality of fuel nozzles (third fuel nozzles 70). The windbreak cover 100 includes the top plate 110 extending in the circumferential direction, and the circumferential side wall 120 that connects the end portion 111 of the top plate 110 in the circumferential direction and the combustion cylinder 36. The windbreak cover 100 is formed by the top plate 110 and the circumferential side wall 120, and has the suction opening portion 130 for taking in the combustion air. The dimension Ld in the radial direction of the combustion cylinder 36 in the suction opening portion 130 is smaller than the dimension Ls in the circumferential direction in the suction opening portion 130 in at least a partial region in the circumferential direction.

According to the configuration of (1) described above, since the windbreak cover 100 is provided, it is possible to suppress the flow rate deviation of the combustion air between the plurality of fuel nozzles (third fuel nozzles 70) disposed at an interval in the circumferential direction of the combustion cylinder 36 in the side portion of the combustion cylinder 36. In addition, since the dimension Ld of the combustion cylinder 36 in the radial direction in the suction opening portion 130 is smaller than the dimension Ls of the suction opening portion 130 in the circumferential direction in at least a partial region in the circumferential direction, even when the plurality of combustion cylinders 36 are annularly disposed around the rotor 8 of the gas turbine 1, it is possible to suppress the pressure loss of the combustion air flowing into the fuel nozzle (third fuel nozzle 70) by securing the size of the suction opening portion 130 while preventing the interference with the windbreak cover 100 provided in the adjacent combustion cylinders 36.

(2) In some embodiments, in the configuration of (1) described above, the windbreak cover 100 may include the upstream side wall 140 that connects the end portion 113 of the top plate 110 on the upstream side of the combustion cylinder 36 and the combustion cylinder 36.

According to the configuration of (2) described above, the upstream side wall 140 closes the space between the top plate 110 and the combustion cylinder 36 in the end portion 113 of the top plate 110 on the upstream side of the combustion cylinder 36. Therefore, the combustion air flows into the fuel nozzle (third fuel nozzle 70) from the downstream side of the combustion cylinder 36. In this way, the combustion air flowing into the fuel nozzle (third fuel nozzle 70) from the downstream side of the combustion cylinder 36 flows into the combustion cylinder 36 by changing the direction of the flow inside the fuel nozzle (third fuel nozzle 70). Therefore, a region where the flow velocity of the combustion air is lowered on the upstream side of the combustion cylinder 36 in the outlet of the fuel nozzle (third fuel nozzle 70) is less likely to form. In this manner, it is possible to suppress the occurrence of abnormal combustion in the vicinity of the outlet of the fuel nozzle (third fuel nozzle 70).

(3) In some embodiments, in the configuration of (1) or (2) described above, the dimension Lax in the axial direction of the combustion cylinder 36 in the top plate may be smaller than the dimension in the circumferential direction (dimension Ls in the circumferential direction in the suction opening portion 130) in the top plate 110.

According to the configuration of (3) described above, it is possible to suppress the interference between the acoustic device 60 provided in the combustion cylinder 36 and the windbreak cover 100 on the upstream side of the combustion cylinder 36 with respect to the windbreak cover 100.

(4) In some embodiments, in the configuration of any one of (1) to (3) described above, the combustion cylinders 36 may include at least the first combustion cylinder 36A and the second combustion cylinder 36B disposed adjacent to the first combustion cylinder 36A, which are annularly disposed at a plurality of locations around the rotor 8 of the gas turbine 1. When the straight line passing through the axis O of the rotor 8 and the center Cp of the first combustion cylinder 36A is defined as the first straight line L1 and the straight line passing through the axis O and the center Cp of the second combustion cylinder 36B is defined as the second straight line L2 when viewed in the direction of the axis O of the rotor 8, a portion of the top plate 110 located in the region interposed between the first straight line L1 and the second straight line L2 may extend parallel to the bisector Lh of the angle formed by the first straight line L1 and the second straight line L2.

According to the configuration of (4) described above, even when the interval between the first combustion cylinder 36A and the second combustion cylinder 36B is relatively narrow, the size of the suction opening portion 130 is easily secured, and the pressure loss of the combustion air flowing into the fuel nozzle (third fuel nozzle 70) is easily suppressed.

(5) In some embodiments, in the configuration according to any one of (1) to (4) described above, the windbreak cover 100 may be configured so that all of the plurality of fuel nozzles (third fuel nozzles 70) are located between the circumferential side wall 120 on one side in the circumferential direction and the circumferential side wall 120 on the other side in the circumferential direction.

According to the configuration of (5) described above, all of the plurality of fuel nozzles (third fuel nozzles 70) disposed at an interval in the circumferential direction of the combustion cylinder 36 can be covered with one windbreak cover 100. Therefore, the configuration of the windbreak cover 100 can be relatively simplified.

(6) In some embodiments, in any of the configurations of (1) to (5) described above, the windbreak cover 100 may include the bulkhead 150 that connects the top plate 110 and the combustion cylinder 36 and that divides a space enclosed by the top plate 110, the circumferential side wall 120, and the combustion cylinder 36 in the circumferential direction.

According to the configuration of (6) described above, the opening area of the suction opening portion 130 can be appropriately set depending on the position of the bulkhead 150 in the circumferential direction. In this manner, it is easy to suppress the flow rate deviation of the combustion air between the plurality of fuel nozzles (third fuel nozzles 70). In addition, according to the configuration of (6) described above, the top plate 110 can be reinforced by the bulkhead 150.

(7) In some embodiments, in the configuration of (6) described above, in at least a partial region in the circumferential direction, the dimension Ld of the combustion cylinder 36 in the radial direction in the suction opening portion 130 may be smaller than the distance Ls1 in the circumferential direction between the two bulkheads 150 adjacent to each other in the circumferential direction across at least one fuel nozzle (third fuel nozzle 70), or the distance Ls2 in the circumferential direction between the circumferential side wall 120 and the bulkhead 150 which are adjacent to each other in the circumferential direction across the fuel nozzle (third fuel nozzle 70).

According to the configuration of (7) described above, even when the plurality of combustion cylinders 36 are annularly disposed around the rotor 8 of the gas turbine 1, it is possible to suppress the pressure loss of the combustion air flowing into the fuel nozzle (third fuel nozzle 70) by securing the size of the suction opening portion 130 while preventing the interference with the windbreak cover 100 provided in the adjacent combustion cylinders 36.

(8) The combustor 4 of the gas turbine 1 according to at least one embodiment of the present disclosure includes the combustion cylinder 36 having any of the configurations of (1) to (7) described above, and the burner (first combustion burner 38 and second combustion burner 44) provided on the upstream side of the combustion cylinder 36 and used for combusting the fuel.

According to the configuration of (8) described above, it is possible to realize the combustor 4 which can suppress the pressure loss of the combustion air flowing into the fuel nozzle (third fuel nozzle 70) while suppressing the flow rate deviation of the combustion air between the plurality of fuel nozzles (third fuel nozzles 70) disposed at an interval in the circumferential direction of the combustion cylinder 36 in the side portion of the combustion cylinder 36.

(9) The gas turbine 1 according to at least one embodiment of the present disclosure includes the rotor 8, and the plurality of combustors 4 having the configuration described in (8) above, which are annularly disposed around the rotor 8.

According to the configuration of (9) described above, the efficiency of the gas turbine 1 is improved.

### REFERENCE SIGNS LIST

1: gas turbine
8: rotor
36: combustion cylinder
36A: first combustion cylinder
36B: second combustion cylinder
100: windbreak cover
110: top plate
120: circumferential side wall
130: suction opening portion
140: upstream side wall
150: bulkhead

1. A gas turbine combustion cylinder comprising:
a combustion cylinder;
a plurality of fuel nozzles disposed at an interval in a circumferential direction of the combustion cylinder on a side portion of the combustion cylinder; and
a windbreak cover disposed to enclose at least one of the plurality of fuel nozzles,
wherein the windbreak cover includes a top plate extending in the circumferential direction and a circumferential side wall that connects an end portion of the top plate in the circumferential direction and the combustion cylinder, the windbreak cover being formed by the top plate and the circumferential side wall and having a suction opening portion for taking in combustion air, and
a dimension in a radial direction of the combustion cylinder in the suction opening portion is smaller than a dimension in the circumferential direction in the suction opening portion in at least a partial region in the circumferential direction.

2. The gas turbine combustion cylinder according to claim 1,
wherein the windbreak cover includes an upstream side wall that connects an end portion of the top plate on an upstream side of the combustion cylinder and the combustion cylinder.

3. The gas turbine combustion cylinder according to claim 1,
wherein a dimension in an axial direction of the combustion cylinder in the top plate is smaller than a dimension in the circumferential direction in the top plate.

4. The gas turbine combustion cylinder according to claim 1,
wherein the combustion cylinders include at least a first combustion cylinder and a second combustion cylinder disposed adjacent to the first combustion cylinder, which are annularly disposed at a plurality of locations around a rotor of a gas turbine, and
when a straight line passing through an axis of the rotor and a center of the first combustion cylinder is defined as a first straight line and a straight line passing through the axis and a center of the second combustion cylinder is defined as a second straight line when viewed in an axial direction of the rotor, a portion of the top plate located in a region interposed between the first straight line and the second straight line extends parallel to a bisector of an angle formed by the first straight line and the second straight line.

5. The gas turbine combustion cylinder according to claim 1,
wherein the windbreak cover is configured so that all of the plurality of fuel nozzles are located between a circumferential side wall on one side in the circumferential direction and a circumferential side wall on the other side in the circumferential direction.

6. The gas turbine combustion cylinder according to claim 1,
wherein the windbreak cover includes a bulkhead that connects the top plate and the combustion cylinder and that divides a space enclosed by the top plate, the circumferential side wall, and the combustion cylinder in the circumferential direction.

7. The gas turbine combustion cylinder according to claim 6,
wherein in at least a partial region in the circumferential direction, the dimension in the radial direction of the combustion cylinder in the suction opening portion is smaller than a distance in the circumferential direction between two bulkheads adjacent to each other in the circumferential direction across at least one of the fuel nozzles or a distance in the circumferential direction between the circumferential side wall and the bulkhead which are adjacent to each other in the circumferential direction across the fuel nozzle.

8. A gas turbine combustor comprising:
the combustion cylinder according to claim 1; and
a burner provided on an upstream side of the combustion cylinder and used for combusting a fuel.

9. A gas turbine comprising:
a rotor; and
a plurality of the combustors according to claim 8, which are annularly disposed around the rotor.
